(19) United States
(12) Patent Application Publication
(10) Pub. No.: US 2023/0254021 A1
(43) Pub. Date: Aug. 10, 2023

(54) WIRELESS ENERGY AND DATA COMMUNICATION IN A WIRELESS COMMUNICATION NETWORK

(71) Applicant: Telefonaktiebolaget LM Ericsson (publ), Stockholm (SE)

(72) Inventors: Nafiseh SHARIATI, Stockholm (SE); Hamed FARHADI, Stockholm (SE); Maksym GIRNYK, Solna (SE)

(21) Appl. No.: 18/004,690

(22) PCT Filed: Jul. 10, 2020
(86) PCT No.: PCT/SE2020/050722

§ 371 Date: Jan. 9, 2023

(51) Int. Cl. H04B 7/06

(52) U.S. Cl. CPC H04B 7/0617; H04B 7/0626

(57) ABSTRACT

The present disclosure relates to a method performed by a network apparatus having a directional antenna arrangement in a wireless communication network. The method includes obtaining a scheduling decision for a wireless device served by the wireless communication network based on a traffic status and an energy status of the wireless device. Further, the method includes determining a first beamforming weight vector for information transmission and/or a second beamforming weight vector for energy transfer based on Channel State Information associated with the wireless device. The method further includes applying, to a signal, at least one of the determined first beamforming weight vector in order to transmit an information signal via the directional antenna arrangement to the wireless device and the determined second beamforming weight vector in order to transmit an energy signal via the directional antenna arrangement to the wireless device, based on the obtained scheduling decision.

### TECHNICAL FIELD

The present disclosure relates to wireless energy and data communication, and in particular to methods and control device configured to enable wireless data communication and energy transfer to remote devices.

### BACKGROUND

Radio frequency (RF) signals can be used for both data communication and energy transfer to remote devices. Data communication can be performed by encoding messages into ‘information signals’ at the transmitter side and decoding the noisy received signal at the receiver side to extract the transmitted message. Energy transfer can be performed by transmitting ‘energy signals’, i.e. signals designed specifically to carry energy at the transmitter side and harvesting the received energy at the receiver side by means of suitable energy harvesting circuitry.

The emergence of internet of things (IoT), e.g. 5G massive machine-type-communications (mMTC) use cases, including billions of low power devices calls for wireless energy transfer technologies to act as an efficient way of charging geographically widespread devices, enabling sustainable, long-life, and energy-efficient operation.

To perform joint data communication and energy transfer, a transmitter can transmit a combination of information signals and energy signals and a receiver can try to decode the information signal and harvest the energy from the energy signal. However, due to practical limitations, a receiver cannot harvest energy from the signal intended for decoding. Hence, decoupling between the processes of decoding and energy harvesting is required. This could be realized by means of various receiver architectures, e.g., ‘power splitting’, ‘time switching’, or ‘antenna switching’.

At the receiver side one may provide an energy harvesting circuit comprising a bandpass filter, a rectifying circuit, and a low pass filter. Thereby, the received signal passes through the bandpass filter employed after the receiver antenna to perform impedance matching and passive filtering. After that, the RF signal is passed to the rectifying circuit, i.e. a passive electronic device usually comprising diodes, resistors, and capacitors that converts RF power to direct-current power. This is followed by the low-pass filter that removes the harmonic frequencies and prepares the power for storage in a storage device/battery.

However, there is still a need for improvements in the art, and in particular there is a need for improvements in terms of energy transfer efficiency for the energy signal(s) and improvements with respect to interference levels for the information signal(s).

### SUMMARY

It is therefore an object of the present disclosure to provide a method performed by a network apparatus in a wireless communication network, computer-readable storage medium, a control device for operating network apparatus in a wireless communication system, and a network apparatus, which seek to mitigate, alleviate, or eliminate one or more of the deficiencies in the art and disadvantages singly or in any combination.

This object is achieved by means of a method, a computer-readable storage medium, a control device, and a network apparatus as defined in the appended claims. The term exemplary is in the present context to be understood as serving as an instance, example or illustration.

According to a first aspect of the present disclosure, there is provided a method performed by a network apparatus in a wireless communication network, where the network apparatus has a directional antenna arrangement. The method comprises obtaining a scheduling decision for a wireless device served by the wireless communication network based on a traffic status and an energy status of the wireless device. Further, the method comprises determining a first beamforming weight vector (W_{D}) for information transmission and/or a second beamforming weight vector (W_{E}) for energy transfer based on Channel State Information (CSI) associated with the wireless device. The method further comprises applying, to a signal, at least one of the determined first beamforming weight vector (W_{D}) in order to transmit an information signal via the directional antenna arrangement to the wireless device and the determined second beamforming weight vector (W_{E}) in order to transmit an energy signal via the directional antenna arrangement to the wireless device, based on the obtained scheduling decision.

An advantage of the proposed method is that the transmission from the network apparatus may be optimized according to the current status, and effectively the need, of the wireless device. In more detail, the present inventors realized that it is advantageous to compute separate beamforming weight vectors depending on the objective of the transmission and that it is therefore advantageous to have a scheduling policy supporting such an optimization. Accordingly, depending on if the wireless device or user equipment (UE) is scheduled for information transmission or energy transfer, an optimal set of beamforming weight vectors may be generated in order to improve data throughput as well as received energy. For example by optimizing towards one more first Key Performance Indicators (KPIs), such as e.g. a maximized signal-to-interference-and-noise ratio (SINR), during information transmission, and towards one or more second KPls, such as e.g. a maximized received energy, during energy transfer, the overall network performance may be improved. In other words, the herein proposed solution provides a means for the network apparatus (e.g. base station) to operate according to two different modes, thereby increasing overall network performance.

In particular, the herein proposed solution is advantageous in networks serving low complexity devices (IoT devices) as the energy transfer can be used beside the common communication link in order to increase the lifetime of such devices. Especially in situations where such devices are arranged at remote and hard-to-reach places, making them difficult to maintain or replace with frequent intervals.

According to a second aspect of the present disclosure, there is provided a (non-transitory) computer-readable storage medium storing one or more programs configured to be executed by one or more processors of a processing device, the one or more programs comprising instructions for performing the method according to any one of the embodiments disclosed herein. With this aspect of the disclosure, similar advantages and preferred features are present as in the previously discussed first aspect of the disclosure.

The term “non-transitory,” as used herein, is intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link. Thus, the term “non-transitory”, as used herein, is a limitation of the medium itself (i.e., tangible, not a signal) as opposed to a limitation on data storage persistency (e.g., RAM vs. ROM).

According to a third aspect of the present disclosure, there is provided control device for operating a network apparatus in a wireless communication system, where the network apparatus comprises a directional antenna arrangement configured to transmit and receive a wireless signal. The control device comprises control circuitry connectable to the directional antenna arrangement. The control circuitry is configured to obtain a scheduling decision for a wireless device served by the wireless communication network based on a traffic status and the energy status of the wireless device. Further, the control circuitry is configured to determine a first beamforming weight vector (W_{D}) for information transmission and/or a second beamforming weight vector (W_{E}) for energy transfer based on Channel State Information (CSI) associated with the wireless device. The control circuitry is further configured to apply, to a signal, at least one of the determined first beamforming weight vector (W_{D}) in order to transmit an information signal via the directional antenna arrangement to the wireless device and the determined second beamforming weight vector (W_{E}) in order to transmit an energy signal via the directional antenna arrangement to the wireless device, based on the obtained scheduling decision. With this aspect of the disclosure, similar advantages and preferred features are present as in the previously discussed first aspect of the disclosure.

According to a fourth aspect of the present disclosure, there is provided network apparatus for operating in a wireless communication system. The network apparatus comprises a directional antenna arrangement having a directional antenna configured to transmit and receive a wireless signal and a control device according to any one of the embodiments disclosed herein. With this aspect of the disclosure, similar advantages and preferred features are present as in the previously discussed first aspect of the disclosure.

Further embodiments of the disclosure are defined in the dependent claims. It should be emphasized that the term “comprises/comprising” when used in this specification is taken to specify the presence of stated features, integers, steps, or components. It does not preclude the presence or addition of one or more other features, integers, steps, components, or groups thereof.

These and other features and advantages of the present disclosure will in the following be further clarified with reference to the embodiments described hereinafter.

### BRIEF DESCRIPTION OF THE DRAWINGS

Further objects, features and advantages of embodiments of the disclosure will appear from the following detailed description, reference being made to the accompanying drawings, in which:

FIG. 1 is a schematic flow chart representation of a method performed by a network apparatus in a wireless communication network in accordance with an embodiment of the present disclosure.

FIG. 2 is a schematic chart of four different scheduling states of a wireless device served by a wireless communication network in accordance with an embodiment of the present disclosure.

FIG. 3 is a schematic flow chart representation of a method in accordance with an embodiment of the present disclosure.

FIG. 4 is a schematic illustration of a network apparatus having a control device for operating the network apparatus in a wireless communication system in accordance with an embodiment of the present disclosure.

### DETAILED DESCRIPTION

Aspects of the present disclosure will be described more fully hereinafter with reference to the accompanying drawings. The control device and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not necessarily intended to limit the scope. As used herein, the singular forms “a”, “an” and “the” are intended to include the plural forms as well, unless the context clearly indicates otherwise.

Those skilled in the art will appreciate that the steps, services and functions explained herein may be implemented using individual hardware circuitry, using software functioning in conjunction with a programmed microprocessor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

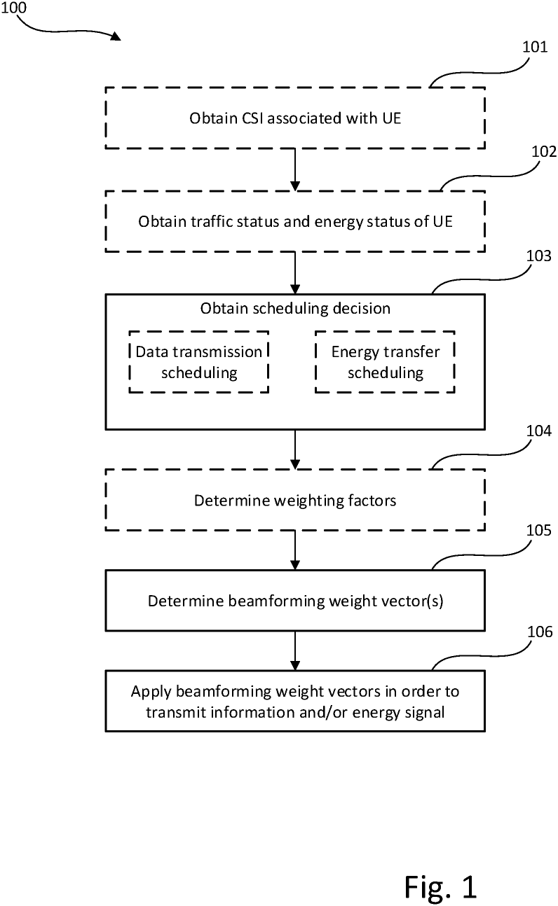

FIG. 1 is a schematic flow chart representation of a method 100 performed by a network apparatus in a wireless communication network, where the network apparatus has a directional antenna arrangement. In more detail, a directional antenna arrangement is in the present context to be understood as an antenna arrangement whose antenna beam can be controlled by beamforming techniques so that it radiates and/or receives greater power in specific directions. In some embodiments, the directional antenna arrangement is an antenna array (or array antenna) comprising a plurality of connected antenna elements which work together as a single antenna. Beamforming may accordingly be understood as a signal processing technique used for directional signal transmission or reception in antenna array. This may be achieved by controlling the antenna elements in the antenna array in such a way that signals at particular angles experience constructive interference while others experience destructive interference. Beamforming can be used at both the transmitting and receiving ends in order to achieve spatial selectivity.

When using an antenna array, beamforming may be applied in order to improve the overall communication system performance. However, if one were to use the same or similar criterion to calculate beamforming weights for both data and energy transmissions one may experience inadequate performance. Therefore, the present inventors realized that by determining beamforming weights where specific constraints and objectives are taken into account for each of those transmission phases, improvements in terms of increased network performance are readily achievable.

Accordingly, the following disclosure proposes a solution for joint data/information and energy transmissions in a wireless communication network such as e.g. a cellular network. The proposed solution utilizes a principle of beamforming data and energy signals, and more particularly beamforming according to specific optimizations for each of these transmissions (i.e. information and energy transmissions) applied to a user equipment (UE) that may be optimized in accordance with different scheduling policies.

The herein proposed beamforming design aims to target improved data/information reception for data/information transmission while attempting to increase/maximize harvested energy for energy transmission. Stated differently, the first beamforming weight vector (for information/data transmission) may be computed in order to optimize towards one or more first KPIs related to data/information reception and/or transmission. Analogously, the second beamforming weight vector (for energy transfer) may be computed in order to optimize towards one or more second KPIs related to energy transfer. Such criteria may be met, for example, by maximizing the Signal-To-Noise Ratio (SNR) for data transmission and maximizing received energy while maintaining interference level at the data/information signal receiving UEs at a (predefined) threshold. In some embodiments, the beamforming for information transmission may be optimized towards maximizing a Signal-To-Noise-And-Interference (SINR) ratio, minimization of a mean square error of the received signal, and so forth. In other words, the beamforming for information transmission may be optimized towards maximizing or minimizing of one or more predefined data performance metrics. Analogously, the beamforming for energy transfer may be optimized towards maximizing or minimizing of one or more predefined energy performance metrics. The present disclosure also proposes policies for scheduling UEs for data and energy transmissions for example based on UEs′ buffer and energy level status.

Moving on, the method 100 comprises obtaining 103 a scheduling decision for a wireless device served by the wireless communication network based on a traffic status and an energy status of the wireless device. The traffic status of the wireless device indicates the wireless device’s need for data transfer and may for example be obtained by measuring or obtaining a data buffer size associated with the wireless device, a number of negative acknowledgment (NAK) signals that have been received, delay in data packet delivery, a traffic priority of the wireless device, and so forth. The energy status of the wireless device indicates the wireless device’s need for energy transfer and may for example be obtained by measuring or obtaining a state of charge of an energy storage device of the wireless device, an energy transfer request, and so forth. In some embodiments, the method 100 further comprises obtaining 102 the traffic status and the energy status of the wireless device. The term obtaining is herein to be interpreted broadly and encompasses receiving, retrieving, collecting, acquiring, making, determining and so forth.

In more detail, a scheduling decision is obtained 103 based on different types of information that correspond to different objects. For example, for information transmission the scheduling is done based on the wireless device’s traffic status, while for energy transfer the scheduling is done based on the wireless device’s energy status. Accordingly, the wireless device will be scheduled for information transmission and/or for energy transmission based on the available information of the wireless device.

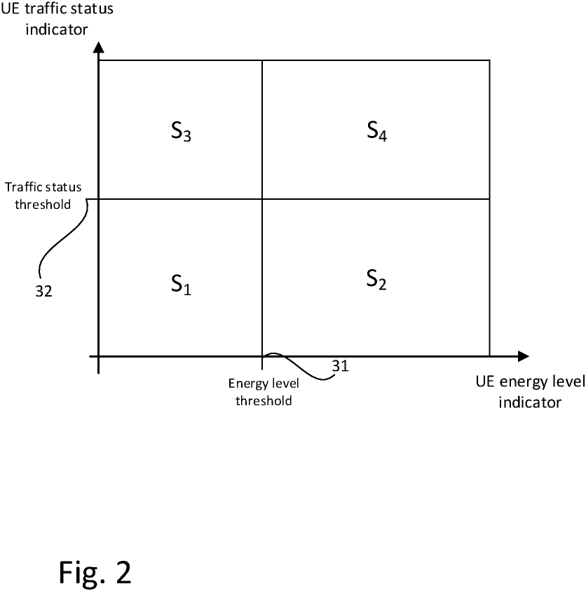

In some embodiments, the obtaining 103 of the scheduling decision comprises determining a scheduling state of the wireless device. Referring now to FIG. 2, the example scheduling states S₁ - S₄ of the wireless device are indicative of the wireless device’s need for information transmission (data communication) and/or energy transfer. FIG. 2 is a schematic chart illustrating how the scheduling decision may be taken based on the obtained traffic status and energy status of the wireless device in accordance with an embodiment of the present disclosure.

In more detail, the x-axis represents an indicator the wireless device’s energy level (e.g. state of charge of a battery of the wireless device), while the y-axis represents an indicator of the wireless device’s traffic status (e.g. data buffer size of the wireless device). Thus, a high energy level indicates a reduced need for energy transfer and a high traffic status indicates an increased need for information transmission. The chart also has a marker for an energy status threshold 31 and a marker for a traffic status threshold 32. Accordingly, based on these thresholds, each wireless device can be assigned one out of four scheduling states (S₁, S₂, S₃, S₄).

The states may be assigned to each wireless device in accordance with the following.
S₁: If the energy level is below the energy level threshold 31, and the traffic status indicator is below the traffic status threshold 32.
S₂: If the energy level is above the energy level threshold 31, and the traffic status indicator is below the traffic status threshold 32.
S₃: If the energy level is below the energy level threshold 31, and the traffic status indicator is above the traffic status threshold 32.
S₄: If the energy level is above the energy level threshold 31, and the traffic status indicator is above the traffic status threshold 32.

Accordingly, the scheduled transmission for a wireless device in each state may be configured as follows.
S₁: The wireless device is scheduled for energy transfer only.
S₂: The wireless device is not scheduled for any one of energy transfer and information transmission.
S₃: The wireless device is scheduled for both energy transfer and information transmission.
S₄: The wireless device is scheduled for information transmission only.

Reverting back to FIG. 1, the method 100 comprises determining 105 a first beamforming weight vector (W_{D}) for information communication and/or a second beamforming weight vector (W_{E}) for energy transfer based on Channel State Information (CSI) associated with the wireless device. The beamforming weight vectors may be determined 105 using different methods, such as e.g. reciprocity-based beamforming or codebook-based beamforming. In more detail, for codebook-based beamforming, the wireless device sends a CSI report comprising an index of one or more predefined beamforming weight vectors, while as for the reciprocity-based beamforming the CSI may be determined at the base station (BS) side and used for determining the one or more beamforming weight vectors. Thus, the method 100 may comprise a step of obtaining 101 the Channel State Information (CSI) associated with the wireless device. In some embodiments the step of obtaining 101 the CSI may comprises obtaining a CSI report of the wireless device or (directly) determining (BS side) the CSI associated with the wireless device. The CSI may be construed as known channel properties of a communication link. More specifically, this information (i.e. the CSI) describes how a signal propagates from the transmitter to the receiver (wireless device) and represents the combined effect of, for example, scattering, fading, and power decay with distance.

Accordingly, at least two beamforming weight vectors are determined 105, corresponding to the two different objectives (i.e. information transmission and energy transmission). In more detail, each of the beamforming weight vectors is determined/computed 105 in order to optimize a specific objective or function. For example, the first beam forming weight vector (W_{D}) may be computed in order to maximize signal-to-interference-and-noise (SINR) of a radio signal to be transmitted via the directional antenna arrangement to the wireless device.

Accordingly, the first beamforming weight vector (W_{D}), i.e. beamforming weight vector associated with the information transmission, may be computed according to equation (1) below.

$${max}_{{W}_{D}} \sum S I N R = f \left({W}_{D} , H , {H}_{i n t e r f}\right) s u b j e c t t o {P}_{a n t} \left({W}_{D}\right) \leq {P}_{T}$$

Here, the function f() represents the information transmission objective, H is/are the desired channel(s), and H_{interf} is/are the interference channel(s). Pₐₙₜ is the beamforming vector power and P_{T} is a vector comprising the allocated power for transmission per antenna. It should be noted that the per antenna power constraint may alternatively be a total power constraint per antenna array.

Similarly, the second beam forming weight vector (W_{E}) may be computed in order to maximize received power (P_{R}) of a radio signal to be transmitted via the directional arrangement to the wireless device. In more detail, the second beamforming weight vector (W_{E}), i.e. beamforming weight vector associated with the energy transfer, may be computed according to equation (2) below.

$$\begin{matrix}{max}_{{W}_{E}} {P}_{R} = g \left({W}_{E} , H\right) s u b j e c t t o {P}_{a n t} \left({W}_{E}\right) \leq {P}_{T} a n d I N T E R F \\ \left({U}_{d}\right) \leq γ\end{matrix}$$

Here, the function g() represents the energy transfer objective and P_{R} is the received power. INTERF(U_{d}) is interference at data receiving UEs, i.e. U_{d}, that are scheduled for both information transmission and energy transfer (e.g. UEs in state S₃ mentioned in the foregoing), wherefore INTERF(U_{d}) should be kept at a level below a defined threshold γ that is set so that the UE can perform successful decoding of the information signal. Note that in some embodiments, the energy signal is pseudo-random, therefore if the information signal is known, the caused interference can also be cancelled out at the receiver side. Another alternative for dealing with interference caused by energy signals could be to schedule them on separate frequency band, e.g. in Frequency Division Multiplexing (FDM) operation mode. For Time Division Multiplexing (TDM), one may use separate DL time slots for data transmission and for transmitting energy signals.

Further, the method 100 comprises applying 106, to a signal (to be transmitted), at least one of the determined first beamforming weight vector (W_{D}) and the determined second beamforming weight vector (W_{E}), in order to transmit an information signal and an energy signal via the directional antenna arrangement to the wireless device, respectively. The terminology “apply a beamforming weight vector to a signal” may be understood as forming a signal to be transmitted toward the receiver using the beamforming weight vector.

In reference to the exemplary scheduling states illustrated in FIG. 2, the transmission to the wireless device(s) may be performed as follows.
If a wireless device is in state S₁, then it is scheduled for energy transfer over a given resource block (i.e. given slot in the time/frequency plane), and the second beamforming vector (W_{E}) is applied to the energy signal to be transmitted via the directional antenna arrangement to the wireless device.
If a wireless device is in state S₂, then it is not scheduled and no transmission should occur to the wireless device via the directional antenna arrangement.
If a wireless device is in state S₃, then it is scheduled for both information transmission and energy transfer. These signal transmissions may occur by transmission over either two different resource blocks (in frequency or time) or over one resource block. In the first case, the first beamforming vector W_{D} may be applied to an information signal to be transmitted over one of the resource blocks and the second beamforming weight vector W_{E} is applied to the energy signal to be transmitted over the other resource block. In the second case, a superposition of two signals may be transmitted over one resource block. The superimposed signal may be constructed by combining the energy signal beamformed with the second weight vector W_{E} and the information signal, which is beamformed with the first weight vector W_{D}. Moreover, the beamformed information signal and the beamformed energy signal may be combined based on a weighting which specifies the power of each of the two signal components in the superimposed signal. The power ratio (ξ) may for example be computed/determined based on the traffic status and the energy status of the wireless device. For example, if the energy level of the wireless device is full, the weighting factor assigned to the energy signal is zero, and the weighting factor assigned to the information signal is one. Analogously, if the energy level is zero, then weighting factor assigned to the information signal is zero, while the weighting factor assigned to the energy signal is one.
If a wireless device is in state S₄, then it is scheduled only for information transmission (data communication) over a given resource block (i.e. given slot in the time/frequency plane), and the first beamforming weight vector W_{D} is applied in order to transmit an information signal via the directional antenna arrangement to the wireless device.

On the receiver side, the received information signal is decoded and the energy from the energy signal is harvested. The receiver may be provided with integrated or separate architecture for information decoding and energy harvesting. The integrated architecture could have employ ‘power splitting’, ‘time switching’, or ‘antenna switching’ for splitting the signal for decoding or energy harvesting when a superimposed signal is transmitted. In that case with a superimposed signal, a power-splitting ratio (corresponding to the power ratio used for the first and second weighting factors) may be used to specify how much power is dedicated to which of the decoding/harvesting processes.

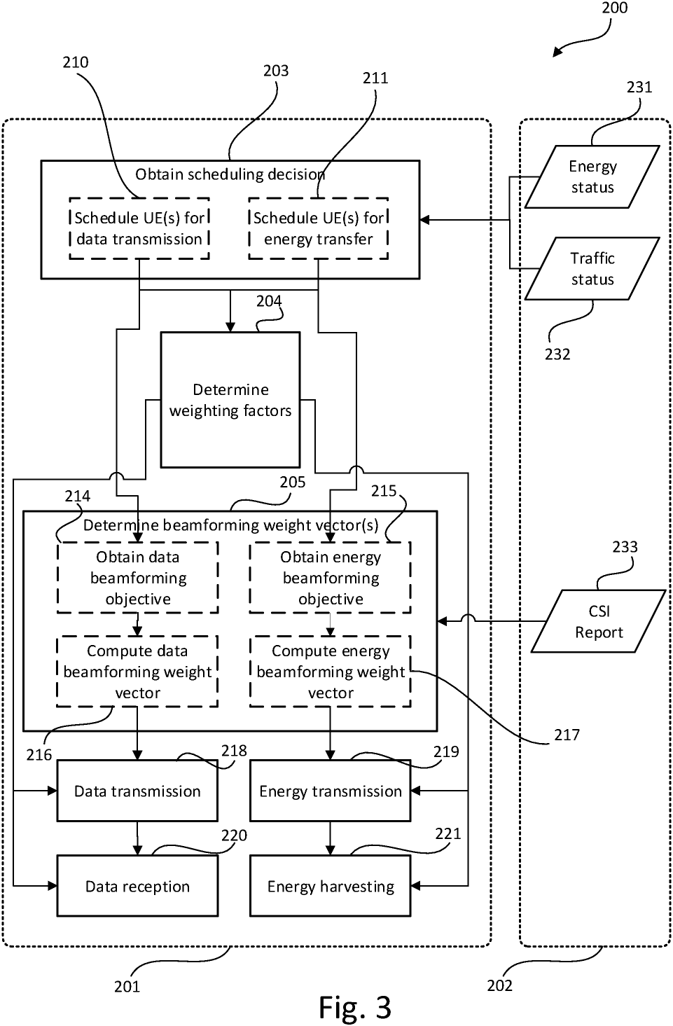

FIG. 3 is a schematic flow chart illustrating uplink (UL) and downlink (DL) transmissions and other steps performed by a UE and network apparatus implementing a method 200 according to an embodiment of the present disclosure. Many of the steps in the flow chart depicted in FIG. 3 have already been discussed in explicit detail in the foregoing as readily appreciated by the skilled artisan, and will therefore for the sake of brevity and conciseness not be unnecessarily repeated. Moreover, FIG. 3 schematically indicates the parts comprised in the uplink transmission phase 202 and the downlink transmission phase 201 of the method 200 in accordance with an embodiment of the present disclosure.

During the UL transmission phase 202, a CSI report 233 of one or more wireless devices is obtained, as well as their energy statuses 231 and traffic statuses 232. The CSI 233 may for example be obtained from the wireless device or a network node, the energy status 231 may for example be obtained from the wireless device, and the traffic status (may also be referred to as load status) 232 may obtained from the wireless device and/or a network node depending on network specifications.

During, the DL transmission phase 201, the method 200 comprises obtaining 203 a scheduling decision for each of the wireless devices based on their corresponding energy status 231 and their corresponding traffic status 232. The obtained 203 scheduling decision may be made/taken locally or received/retrieved from another node or entity in the wireless communication network. Accordingly, the obtained 203 scheduling decision may comprise scheduling 210 one or more UEs for information transmissions and/or scheduling 211 the one or more UE(s) for energy transfer transmissions depending on the obtained statuses 231, 232.

In some embodiments, the obtained 203 scheduling decision is indicative of both an information transmission scheduling 210 and an energy transfer scheduling 211. Thus, the method 200 may further comprises determining 204 weighting factors for the information and energy signals to be transmitted. In more detail, the method may comprise determining 204 a first weighting factor for the information signal to be transmitted and a second weighting factor for the energy signal to be transmitted based on the traffic status and the energy status of the wireless device. The first and second weighting factors are indicative of a power ratio (ξ) between the information signal and energy signal. For example, if the power ratio between the two signals is to be equal, the weighting factors will both be 0,5. In some embodiments, the method 200 may comprise sending the determined 204 weighting factors to the receiver (UE/wireless device) so that the receiver may be configured according to how much power is to be dedicated to which of the decoding/harvesting processes.

Further, the method 200 comprises determining 205 a first beamforming weight vector (W_{D}) for information communication and/or a second beamforming weight vector (W_{E}) for energy transfer based on the obtained CSI 233. Moreover, the determination 205 of the first and second beamforming weight vectors may be further based on the obtained 203 scheduling decision, such that if a wireless device is not scheduled for an energy transfer, then the second beamforming weight vector (W_{E}) need not be determined, and vice versa.

In more detail, the determining 205 may comprise obtaining 214, 215 the corresponding objectives for the information transmission 210 and the energy transfer 211. As already exemplified, the objective for the information transmission may be to maximize the SINR, while the objective for the energy transfer may be to maximize received energy at the UE. These objectives may be predefined, or dynamically set based on one or more predefined rules or based on a request from the UE. Further, the beamforming weight vector for information transmission may be computed 106 according to the obtained 214 objective for the information transmission, and the beamforming weight vector for the energy transfer may be computed according to the obtained 205 objective for the energy transfer.

Further, the method 200 comprises transmitting 218 an information signal and/or transmitting 219 an energy signal to the wireless device(s) in accordance with the obtained 203 scheduling decision(s) by applying the corresponding beamforming weight vectors to the directional antenna arrangement. The energy signal and the information signal may be transmitted 218, 219 separately over different resource blocks (time/frequency switched) or the superposition of these signals may be transmitted as already discussed in the foregoing. Then, the transmitted 218, 219 signals are received 220, 221 at the UE and depending on the scenario, the UE may decode the received signal or harvest the energy from the signal.

Executable instructions for performing these functions are, optionally, included in a non-transitory computer-readable storage medium or other computer program product configured for execution by one or more processors.

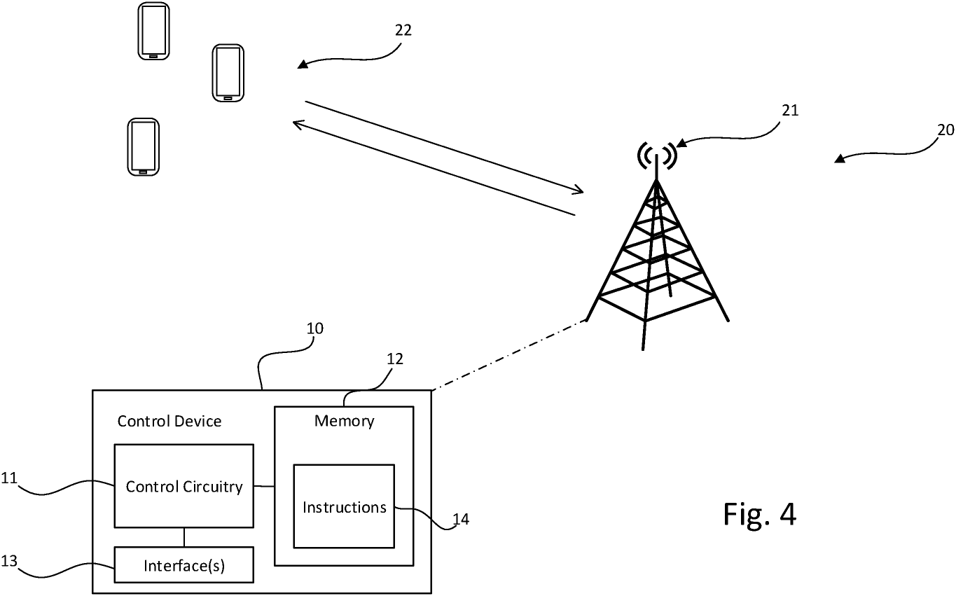

FIG. 4 is a schematic block diagram representation of a control device 10 for operating a network apparatus 20 in a wireless communication system. The figure further illustrates a schematic perspective view of a network apparatus 20, in the form of a base station, comprising such a control device 10. The network apparatus comprises a directional antenna arrangement 21 configured to transmit and receive a wireless signal to/from a remote wireless device 22. The directional antenna arrangement 21 may comprise an antenna array (or array antenna) having a plurality of connected antenna elements which work together as a single antenna. The control device 10 comprises control circuitry 11 (may also be referred to as control unit, controller, one or more processors), a memory 12, a communication interface 13, and any other conventional components/functions required for performing the methods according to any one of the embodiments disclosed herein. In other words, executable instructions 14 for performing these functions are, optionally, included in a non-transitory computer-readable storage medium 12 or other computer program product configured for execution by one or more processors 11.

In more detail, the control circuitry 11 is connectable to the directional antenna arrangement 21 so to be able to transmit and receive signals via the directional antenna arrangement 21. Furthermore, the control circuitry 11 is configured to obtain a scheduling decision for a wireless device 22 served by the wireless communication network based on a traffic status and the energy status of the wireless device. The control circuitry 11 is further configured to determine a first beamforming weight vector (W_{D}) for information transmission and/or a second beamforming weight vector (W_{E}) for energy transfer based on a CSI associated with the wireless device. Then, the control circuitry 11 is configured to apply, to a signal, at least one of:
The determined first beamforming weight vector (W_{D}) in order to transmit an information signal via the directional antenna arrangement to the wireless device, and
the determined second beamforming weight vector (W_{E}) in order to transmit an energy signal via the directional antenna arrangement to the wireless device, based on the obtained scheduling decision.

In summary, the above proposed method and control device provides a means for computing separate beamforming weights/vectors for information communication and for energy transfer purposes based on obtained channel state information (CSI), traffic/load, and energy status of UEs in the network.

Although the description is mainly given for a user equipment (UE) (may also be referred to as a wireless device or terminal), in very general forms, it should be understood by the skilled in the art that “user equipment” is a non-limiting term which means any wireless device, terminal, or node capable of receiving in DL and transmitting in UL (e.g. PDA, laptop, mobile, sensor, fixed relay, mobile relay or even a radio base station, e.g. femto base station). The term UE, as used herein, also encompasses Internet of Things (IoT) devices such as smart sensors, smart appliances, etc.

The present disclosure has been presented above with reference to specific embodiments. However, other embodiments than the above described are possible and within the scope of the disclosure. Different method steps than those described above, performing the method by hardware or software, may be provided within the scope of the disclosure. Thus, according to an exemplary embodiment, there is provided a non-transitory computer-readable storage medium storing one or more programs configured to be executed by one or more processors of a network function, the one or more programs comprising instructions for performing the method according to any one of the above-discussed embodiments. Alternatively, according to another exemplary embodiment a cloud computing system can be configured to perform any of the method aspects presented herein. The cloud computing system may comprise distributed cloud computing resources that jointly perform the method aspects presented herein under control of one or more computer program products.

In other words, the various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The processor(s) (associated with the control device) may be or include any number of hardware components for conducting data or signal processing or for executing computer code stored in memory. The system may have an associated memory, and the memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

Generally speaking, a computer-accessible medium may include any tangible or non-transitory storage media or memory media such as electronic, magnetic, or optical media–e.g., disk or CD/DVD-ROM coupled to computer system via bus. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the disclosure may be at least in part implemented by means of both hardware and software, and that several “means” or “units” may be represented by the same item of hardware.

Although the figures may show a specific order of method steps, the order of the steps may differ from what is depicted. In addition, two or more steps may be performed concurrently or with partial concurrence. For example, separate the scheduling decisions and beamforming for the information transmission and the energy transmission may be performed in parallel by separate modules. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. The above mentioned and described embodiments are only given as examples and should not be limiting to the present disclosure. Other solutions, uses, objectives, and functions within the scope of the disclosure as claimed in the below described patent embodiments should be apparent for the person skilled in the art.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A method performed by a network apparatus in a wireless communication network, the network apparatus having a directional antenna arrangement, the method comprising:
obtaining a scheduling decision for a wireless device served by the wireless communication network based on a traffic status and an energy status of the wireless device;
determining a first beamforming weight vector (W_{D}) for information transmission and/or a second beamforming weight vector (W_{E}) for energy transfer based on Channel State Information (CSI) associated with the wireless device; and
applying, to a signal, at least one of:
the determined first beamforming weight vector (W_{D}) in order to transmit an information signal via the directional antenna arrangement to the wireless device, and
the determined second beamforming weight vector (W_{E}) in order to transmit an energy signal via the directional antenna arrangement to the wireless device, based on the obtained scheduling decision.

2. The method according to claim 1, wherein the step of determining the first beamforming weight vector (W_{D}) for the wireless device comprises:
for the wireless device, computing the first beamforming weight vector (W_{D}) in order to maximize Signal-To-Noise Ratio of a radio signal to be transmitted via the directional antenna arrangement.

3. The method according to claim 1, wherein the step of determining the second beamforming weight vector (W_{E}) comprises:
for the wireless device, computing the second beamforming weight vector (W_{E}) in order to maximize received power of a radio signal to be transmitted via the directional antenna arrangement.

4. The method according to claim 1, further comprising:
obtaining the CSI associated with the wireless device.

5. The method according to claim 1, further comprising:
obtaining the traffic status and the energy status of the wireless device.

6. The method according to claim 1, wherein the energy signal is a pseudo-random signal.

7. The method according to claim 1, wherein the obtained scheduling decision is indicative of a scheduling for information transmission and/or for energy transfer for the wireless device.

8. The method according to claim 1, wherein the step of obtaining a scheduling decision for the wireless device comprises assigning a scheduling state out of a predefined set of scheduling states (S₁, S₂, S₃, S₄) to the wireless device based on the obtained traffic status and the obtained energy status of the wireless device.

9. The method according to claim 1, wherein the step of obtaining a scheduling decision further comprises:
determining a scheduling state of the wireless device, the scheduling state being indicative of a scheduling for information transmission and for energy transfer;
scheduling a transmission over one resource block; and
determining a first weighting factor for the information signal to be transmitted and a second weighting factor for the energy signal to be transmitted based on the traffic status and the energy status of the wireless device, the first and second weighting factors being indicative of a power ratio (ξ) between the information signal and energy signal,
wherein the method further comprises:
combining the information signal and the energy signal in order to transmit a superimposed signal via the directional antenna arrangement to the wireless device based on the determined first and second weighting factors.

10. A computer-readable storage medium storing one or more programs configured to be executed by one or more processors of a processing device, the one or more programs comprising instructions for performing the method according to claim 1.

11. A control device for operating a network apparatus
in a wireless communication system, the network apparatus comprising a directional antenna arrangement configured to transmit and receive a wireless signal, the control device comprising:
control circuitry connectable to the directional antenna arrangement, the control circuitry being configured to:
obtain a scheduling decision for a wireless device served by the wireless communication network based on a traffic status and the energy status of the wireless device;
determine a first beamforming weight vector (W_{D}) for information transmission and/or a second beamforming weight vector (W_{E}) for energy transfer based on Channel State Information, (CSI) associated with the wireless device ; and
apply, to a signal, at least one of:
the determined first beamforming weight vector (W_{D}) in order to transmit an information signal via the directional antenna arrangement to the wireless device, and
the determined second beamforming weight vector (W_{E}) in order to transmit an energy signal via the directional antenna arrangement to the wireless device, based on the obtained scheduling decision.

12. The control device according to claim 11, wherein the control circuitry is further configured to, for the wireless device, determine the first beamforming weight vector (W_{D}) by:
computing the first beamforming weight vector (W_{D}) in order to maximize Signal-To-Noise Ratio of a radio signal to be transmitted via the directional antenna arrangement .

13. The control device according to claim 11, wherein the control circuitry is further configured to, for the wireless device, determine the second beamforming weight vector (W_{E}) by:
computing the second beamforming weight vector (W_{E}) in order to maximize received power of a radio signal to be transmitted via the directional antenna arrangement .

14. The control device according to claim 11, wherein the control circuitry is further configured to:
obtain the CSI associated with the wireless device.

15. The control device according to claim 11, wherein the control circuitry is further configured to:
obtain a traffic status and an energy status of the wireless device .

16. The control device according to claim 11, wherein the obtained scheduling decision is indicative of a scheduling for information transmission and/or for energy transfer to the wireless device.

17. The control device according to claim 11, wherein the control circuitry is further configured to:
assign a scheduling state out of a predefined set of scheduling states (S₁, S₂, S₃, S₄) to the wireless device based on the traffic status and the energy status of the wireless device so to obtain the scheduling decision for the wireless device .

18. The control device according to claim 11, wherein the control circuitry is further configured to:
determine a scheduling state of the wireless device in order to take the scheduling decision, the scheduling state being indicative of a scheduling for information transmission and for energy transfer;
schedule a transmission over one resource block;
determine a first weighting factor for the information signal to be transmitted and a second weighting factor for the energy signal to be transmitted based on the traffic status and the energy status of the wireless device, the first and second weighting factors being indicative of a power ratio (ξ) between the information signal and energy signal; and
combine the information signal and the energy signal in order to transmit a superimposed signal via the directional antenna arrangement to the wireless device based on the determined first and second weighting factors.

19. A network apparatus for operating in a wireless communication system, the network apparatus comprising:
a directional antenna arrangement having a directional antenna configured to transmit and receive a wireless signal; and
a control device according to claim 11.
